(19) United States
(12) Patent Application Publication
(10) Pub. No.: US 2003/0076442 A1
(43) Pub. Date: Apr. 24, 2003

(54) Cradle for camera

(75) Inventors: Tsukasa Kawaguchi, Saitama-ken (JP); Shino Kanamori, Saitama-ken (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/277,143

(22) Filed: Oct. 22, 2002

(30) Foreign Application Priority Data
Oct. 23, 2001 (JP) 2001-324453

(51) Int. Cl. H04N 5/225

(52) U.S. Cl. 348/375

(57) ABSTRACT

A cradle for a digital camera is formed by a cradle main body and a case member. The cradle main body of the cradle forms a bottom portion of the case member. The cradle main body may be fixed to the bottom portion of the case member, or may be able to be attached to and removed from the bottom portion of the case member. By accommodating a camera main body in the case member whose bottom portion is formed by the cradle main body, both the cradle main body and the camera main body can be easily transported and protected.

### BACKGROUND OF THE INVENTION

1. Field of the Invention

The present invention relates to a cradle for a digital camera, and in particular, to a cradle for a digital camera in which the main body of a digital camera is set, and which thereby enables communication between the digital camera and an external device or charging of the digital camera.

2. Description of the Related Art

There are conventional digital cameras in which, by setting the camera main body of the digital camera in a cradle, the camera main body and an external device or a charger can be easily connected via the cradle.

When the camera main body is being carried, a case for carrying and protecting the camera main body is used.

However, if a user brings the camera main body on a trip or the like, the cradle cannot be accommodated within the case and is therefore not very portable. Moreover, if the user needs to connect the camera main body to an external device or a charger while on a trip or the like, it is inconvenient if the cradle is not there.

### SUMMARY OF THE INVENTION

In view of the aforementioned, an object of the present invention is to provide a cradle for a camera which improves the portability of a cradle main body.

In order to achieve the above object, a first aspect of the present invention is provided by a cradle for a digital camera comprising: a cradle main body in which a digital camera is set, and which carries out electrical connection such that communication between the digital camera and an external device is possible and such that charging of the digital camera is possible; and a case member whose bottom portion is formed by the cradle main body, and which can accommodate the digital camera which is set in the cradle main body.

Accordingly, by accommodating the camera main body in the case member whose bottom portion is formed by the cradle main body, both the cradle main body and the camera main body can be transported and protected. Thus, the portability of the cradle main body is improved. Moreover, by setting the camera main body in the cradle main body, the camera main body can easily be connected to an external device or a charging device via the cradle main body.

### BRIEF DESCRIPTION OF THE DRAWINGS

FIG. 1 is a perspective view showing a state in which a cover of a cradle for a camera relating to a first embodiment of the present invention is closed.

FIG. 2 is a perspective view showing a cradle main body of the cradle for a camera relating to the first embodiment of the present invention.

FIG. 3 is a side view showing a state in which the cover of the cradle for a camera relating to the first embodiment of the present invention is open.

FIG. 4 is a perspective view showing a state in which the cover of the cradle for a camera relating to the first embodiment of the present invention is closed and cords are connected.

FIG. 5 is a perspective view showing a state in which a cover of a cradle for a camera relating to a second embodiment of the present invention is closed.

FIG. 6 is a side sectional view showing a state in which the cover of the cradle for a camera relating to the second embodiment of the present invention is closed.

FIG. 7 is a side sectional view showing a state in which a cover of a cradle for a camera relating to a modified example of the second embodiment of the present invention is closed.

### DESCRIPTION OF THE PREFERRED EMBODIMENTS

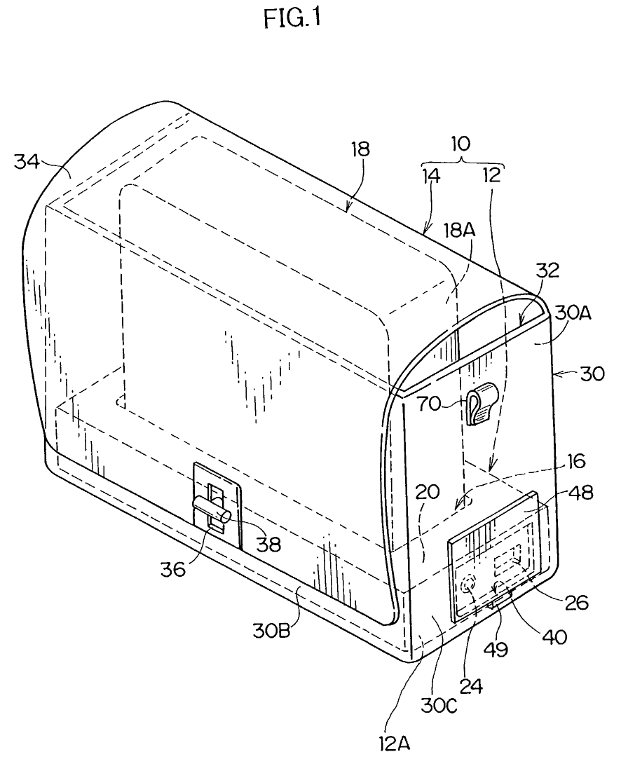

A first embodiment of a cradle for a camera relating to the present invention will be described in accordance with FIGS. 1 through 4.

As shown in FIG. 1, a cradle 10 of the present embodiment is formed by a cradle main body 12 and a case member 14. The cradle main body 12 forms the bottom portion of the case member 14. Note that the cradle main body 12 may be fixed to the bottom portion of the case member 14, or the cradle main body 12 may be attachable to and removable from the bottom portion of the case member 14.

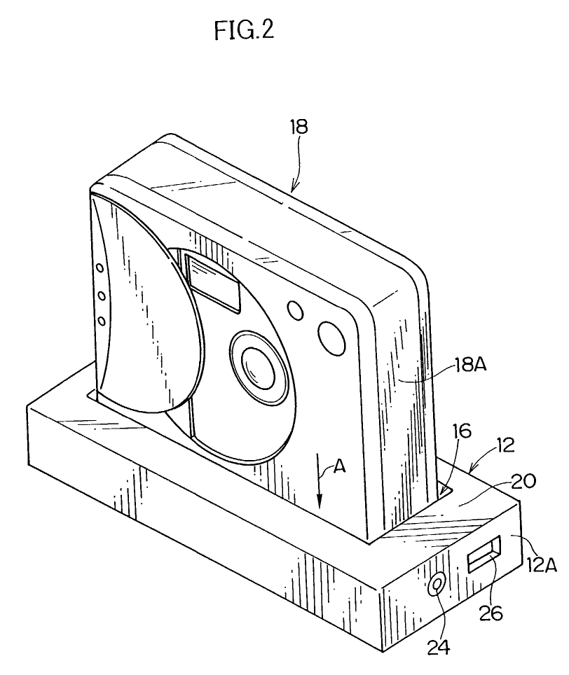

As shown in FIG. 2, a camera main body 18 of a digital camera can be set in a holding portion 16 of the cradle main body 12. A composite terminal (not illustrated), which is for connection with the cradle main body 12 and which integrates a terminal for charging and a USB terminal serving as a terminal for connection to an external device, is formed in the bottom surface of the camera main body 18. The camera main body 18 can be set in the cradle main body 12 by being lowered (i.e., moved in the direction of arrow A in FIG. 2) into the holding portion 16 which is a concave portion (a recess) formed in the top surface 20 of the cradle main body 12.

A terminal for charging and a USB terminal serving as a terminal for connection to an external device, which are both unillustrated and are different than those mentioned previously, are formed at the lower portion of a side surface 18A of the camera main body 18. This terminal for charging and USB terminal are used by being directly connected to respective cables (cords) when the camera main body 18 is not set in the cradle main body 12.

A wall portion is formed so as to stand upwardly at the outer periphery of the holding portion 16 of the cradle main body 12. The configuration of the peripheral surface of the wall portion substantially coincides with the configuration of the outer peripheral surface of the lower portion of the camera main body 18. When the camera main body 18 is inserted in the holding portion 16 of the cradle main body 12, the bottom surface of the camera main body 18 always abuts a predetermined position of the bottom of the holding portion 16.

A terminal 24 for charging and a USB terminal 26, which serves as a terminal for connection to an external device, are formed in a side surface 12A of the cradle main body 12.

As shown in FIG. 1, the case member 14 of the cradle 10 is in the form of a bag. The cradle main body 12 and the camera main body 18 can be placed into and removed from the case member 14 through an upper side opening 32 of a case main body portion 30 which is box-shaped. A cover 34, which closes the upper side opening 32, extends from a rear wall portion 30A of the case main body portion 30. An engagement hole 36 formed at the distal end of the cover 34 is engageable with an engagement portion 38 disposed at the lower portion of a front wall portion 30B of the case main body portion 30. Accordingly, the cover 34 can be set in a closed state (the state shown in FIG. 1) by engaging the engagement hole 36 and the engagement portion 38.

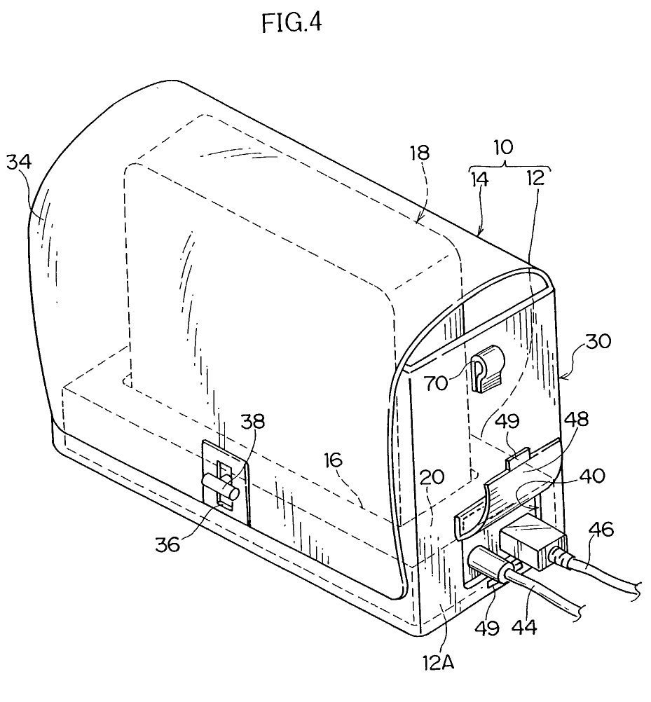

A rectangular cut-out 40 is formed in the lower portion of a side wall portion 30C of the case main body portion 30 of the case member 14 of the cradle 10. The position of cut-out 40 corresponds to the terminal 24 for charging and the USB terminal 26 of the cradle main body 12. Accordingly, a charging cord 44 can be connected to the terminal 24 for charging of the cradle main body 12, and a USB cord 46 can be connected to the USB terminal 26 of the cradle main body 12 (see FIG. 4).

Moreover, a cover member 48 is attached to the side wall portion 30C of the case main body portion 30 of the case member 14 of the cradle 10. The upper edge portion of the cover member 48 is fixed to the side wall portion 30C. In a state in which the charging cord 44 and the USB cord 46 are not connected, the cover member 48 covers the cut-out 40. Note that closing members 49, which set the cover member 48 in the closed state, are disposed at the distal end portion of the cover member 48 and at the side wall portion 30C of the case main body portion 30.

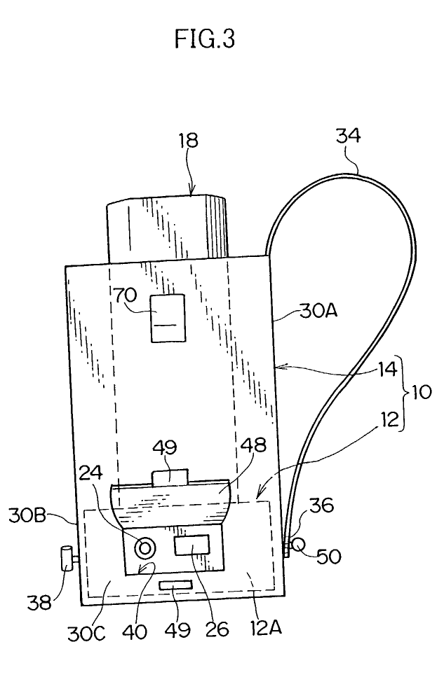

As shown in FIG. 3, the engagement hole 36 formed at the distal end of the cover 34 is engageable with an engagement portion 50 provided at the lower portion of the rear wall portion 30A of the case main body portion 30. The open state of the cover 34 (the state shown in FIG. 3) can be maintained by engaging the engagement hole 36 and the engagement portion 50.

Operation of the present embodiment will now be described.

In the present embodiment, by accommodating the camera main body 18 in the case member 14 whose bottom portion is formed by the cradle main body 12, both the cradle main body 12 and the camera main body 18 can be transported and protected. Thus, the portability of the cradle main body 12 improves.

Further, in the present embodiment, the composite terminal, at which the terminal for charging and the USB terminal of the camera main body 18 are made integral, and the composite terminal connection portion, at which the terminal for charging and the USB terminal formed at the holding portion 16 of the cradle main body 12 are made integral, can be connected together (automatically) merely by setting the camera main body 18 in the holding portion 16 of the cradle main body 12. In this way, the camera main body 18 and the charging cord 44 or the USB cord 46 can be easily connected via the cradle main body 12.

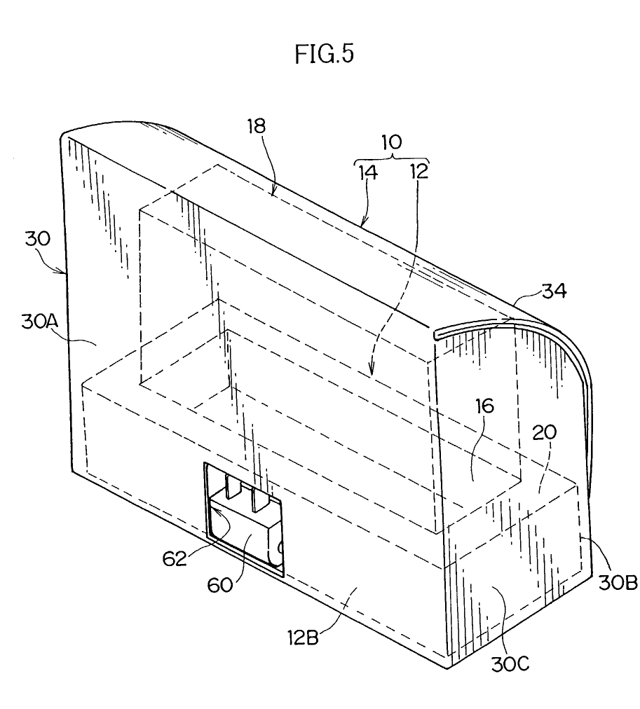

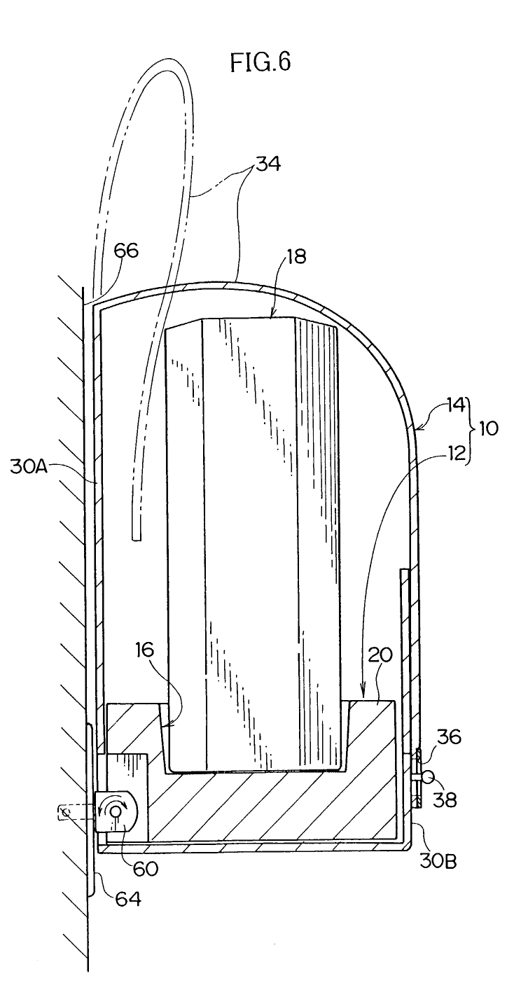

Next, a second embodiment of the cradle for a camera relating to the present invention will be described in accordance with FIG. 5 and FIG. 6.

Note that members which are the same as those of the first embodiment are denoted by the same reference numerals and description thereof is omitted.

The side surface of the cradle has a recess, and the plug may be provided within the recess and is rotatable between a first position, at which the plug is withdrawn into an interior of the recess, and a second position, at which the plug projects out from the recess and can be inserted into an exterior electrical outlet.

As shown in FIG. 5, in the present second embodiment, a power source plug 60, which is mounted so as to be rotatable, is disposed at the central portion, in the transverse (left-right) direction, of a rear portion 12B of the cradle main body 12. The rectangular cut-out 62 is formed in the lower portion of the rear wall portion 30A of the case main body portion 30 of the case member 14 of the cradle 10, at a position opposing the power source plug 60. The cut-out 62 can be closed by a cover (not illustrated).

The power source plug 60 can rotate between the accommodated position shown in FIG. 5 and the position of use shown in FIG. 6. By placing the power source plug 60 in the position of use shown in FIG. 6, the power source plug 60 can be plugged into a power source outlet 64. By plugging the power source plug 60 into the power source outlet 64, the cradle 10 can be held at a position along a wall portion 66 of a building.

Next, operation of the present second embodiment will be described.

In the present embodiment, the same operation and effects as those of the first embodiment are obtained. In addition, as shown in FIG. 6, by plugging the power source plug 60 into the power source outlet 64, the camera main body 18 can be charged while the cradle 10 is held at a position along the wall portion 66 of a building. Therefore, the camera main body 18 and the cradle 10 do not get in the way during charging.

Instead of holding the camera by using a tripod, the power source plug 60 may be plugged into the power source outlet 64 as shown by the two-dot chain line in FIG. 6, such that the cradle and the camera can be held and the cover 34 can be opened and photographing can be carried out.

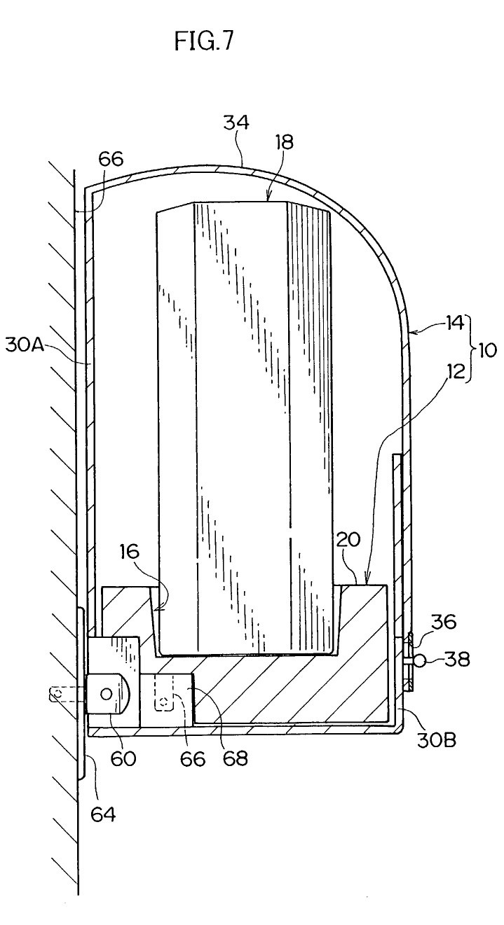

Note that, in the present embodiment, the rotatable power source plug 60 is provided at the cradle main body 12. However, instead, as shown in FIG. 7, the power source plug 60 may be provided at the case member 14, and a power source terminal 66 of the cradle main body 12 may be able to be fit with and separated from a connector 68 provided at the power source plug 60 side. That is, the case member 14 has, at an interior of the case member 14, an electrical outlet (connector) 68 which is electrically connected with the plug 60, and the cradle main body 12, when attached to the case member 14, has a plug (power source terminal) 66 which is inserted into and electrically connected to the electrical outlet 68.

The present invention was explained in detail above with reference to specific embodiments. However, the present invention is not limited to these embodiments, and it will be clear to persons skilled in the art that other various embodiments are possible within the scope of the present invention. For example, in the first embodiment, the charging cord 44 or the USB cord 46 may function also as a shoulder belt, and the charging cord 44 or the USB cord 46 can be connected to a shoulder belt attaching portion 70 provided at the side wall portion 30C of the case main body portion 30. Further, a different engaging means may be used instead of the engagement hole 36 and the engagement portion 38.

Because the present invention is structured as described above, the present invention has the excellent effect of improving the portability of the cradle main body.

What is claimed is:

1. A cradle for a digital camera comprising:
a cradle main body in which a digital camera is set, and which carries out electrical connection such that communication between the digital camera and an external device is possible and such that charging of the digital camera is possible; and
a case member whose bottom portion is formed by the cradle main body, and which can accommodate the digital camera which is set in the cradle main body.

2. The cradle for a digital camera of claim 1, wherein the cradle main body is fixed to the bottom portion of the case member.

3. The cradle for a digital camera of claim 1, wherein the cradle main body can be attached to and removed from the bottom portion of the case member.

4. The cradle for a digital camera of claim 1, wherein the case member is box-shaped, and the cradle main body is disposed at the bottom portion of the case member.

5. The cradle for a digital camera of claim 1, wherein the case member has an opening at a top portion of the case member and a cover that is formed at the opening so as to be able to open and close.

6. The cradle for a digital camera of claim 4, wherein the case member has an opening at a top portion of the case member and a cover that is formed at the opening so as to be able to open and close.

7. The cradle for a digital camera of claim 1, wherein the cradle main body has, at a top surface of the cradle main body, a recess in which the digital camera is set and held.

8. The cradle for a digital camera of claim 7, wherein the cradle main body has, at a bottom surface of the recess, a terminal, which electrically connects with the digital camera set in the cradle main body such that electric power can be supplied to the digital camera.

9. The cradle for a digital camera of claim 7, wherein the cradle main body has at a bottom surface of the recess, a terminal, which electrically connects with the digital camera set in the cradle main body, and enables communication between the digital camera and the external device.

10. The cradle for a digital camera of claim 9, wherein the terminal is a USB terminal.

11. The cradle for a digital camera of claim 1, wherein the cradle has, at an outer surface of the cradle, a terminal for connection which enables connection with the external device.

12. The cradle for a digital camera of claim 1, wherein the cradle has, at an outer surface of the cradle, a terminal, and electric power is supplied from the terminal.

13. The cradle for a digital camera of claim 1, wherein the cradle has a side surface and has, at the side surface, a plug for supply of electric power.

14. The cradle for a digital camera of claim 13, wherein the side surface has a recess, and the plug is provided within the recess and is rotatable between a first position, at which the plug is withdrawn into an interior of the recess, and a second position, at which the plug projects out from the recess and can be inserted into an exterior electrical outlet.

15. The cradle for a digital camera of claim 14, wherein the plug is provided at the cradle main body.

16. The cradle for a digital camera of claim 14, wherein the case member has a side surface, and the plug is provided at the side surface of the case member.

17. The cradle for a digital camera of claim 16, wherein the case member has, at an interior of the case member, an electrical outlet which is electrically connected with the plug, and the cradle main body, when attached to the case member, has a plug which is inserted into and electrically connected to the electrical outlet.
